(19) United States
(12) Patent Application Publication
(10) Pub. No.: US 2021/0350447 A1
(43) Pub. Date: Nov. 11, 2021

(54) Mobile Shopping and Delivery System

(71) Applicant: Michael Golata, Louisville, KY (US)

(72) Inventor: Michael Golata, Louisville, KY (US)

(21) Appl. No.: 17/153,981

(22) Filed: Jan. 21, 2021

Related U.S. Application Data
(60) Provisional application No. 63/022,105, filed on May 8, 2020.

(51) Int. Cl. G06Q 30/06; G06Q 10/08; G06Q 20/08

(52) U.S. Cl. CPC G06Q 30/0637; G06Q 30/0639; G06Q 30/0281; G06Q 20/085; G06Q 10/0833

(57) ABSTRACT

Systems and methods of providing an ordering and delivery service. A mobile shopping and delivery system is accessible by an internet connected user input. The customer uses the user input to direct the mobile shopping and delivery system to provide an available inventory of convenience items to the customer via a mobile delivery platform. The mobile delivery platform is a vehicle stocked with the available inventory of convenience items configured to complete a preprogrammed route at a plurality of intervals. The customer is able to complete an order and arrange for delivery to predetermined locations along the route or directly to the customer's residence. The mobile shopping and delivery system coordinates the delivery and notifies the customer when the mobile delivery platform is near.

### CROSS-REFERENCE TO RELATED APPLICATION

The present application claims priority to, and the benefit of, U.S. Provisional Application No. 63/022,105, which was filed on May 8, 2020 and is incorporated herein by reference in its entirety.

### BACKGROUND

The present invention generally relates to a mobile shopping and delivery solution, and more specifically to a mobile delivery system and method for convenience store items. Accordingly, the present specification makes specific reference thereto. However, it is to be appreciated that aspects of the present invention are also equally amenable to other like applications, devices and methods of manufacture.

Purchasing items from a convenience store typically requires that the prospective customer leave home and shop in person putting them at risk for contracting germs, viruses, and bacteria. Some people opt to use a delivery service in lieu of going to the store and getting their own items. Unfortunately, delivery for certain items can take days or weeks, and can be inconvenient to schedule. A convenience store is a smaller retail business that stocks a range of everyday items and are typically used as a convenient supplement to larger stores. Waiting for or trying to schedule a delivery for convenience store items is currently inefficient. Also, it is not typically cost effective to deliver convenience store products.

The delivery business sector has expanded dramatically from the days of the milk man. Many companies offer forms of delivery including employee delivery, a delivery company, or third party on demand personal shoppers or delivery companies. There is a rapidly accelerating trend toward convenience. Not only is delivery convenient, but it limits interaction with the public limiting the likelihood of disease transmission. While delivery services make sense for larger items, large amounts of items, or prepared food, there is currently no cost effective and efficient delivery option for convenience items. The purchaser is still required to visit the store in person to completer their shopping.

In this manner, the improved shopping system of the present invention accomplishes all of the forgoing objectives, thereby providing an easy solution for customers to purchase and receive convenience store items in a timely manner. A primary feature of the present invention is that convenience store items are more widely accessible and accessible either near to or at the user's residence. The customer will have ready access to convenience store items at a location convenient for the customer. Finally, the improved shopping system of the present invention provides a solution for those who may be prevented from visiting a convenience store by physical disability, lack of transportation, inconvenience, or other obstacles.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a mobile shopping and delivery system. The mobile shopping and delivery system comprises a user input device and a mobile delivery platform. The user input device may be a mobile electronic device or other internet connected user input. The user input device comprises a non-transitory, computer-readable medium comprising software instructions that, when executed by at least one processor, causes the at least one processor to access the shopping and delivery server via a network. The mobile delivery platform comprises a delivery vehicle configured to carry an inventory of convenience items for sale and delivery along a preprogrammed route. The mobile delivery platform further comprises a server communications module for interacting with the shopping and delivery server.

The shopping and delivery server comprises a mobile shopping and delivery component for interacting with the user input and a database of the available inventory. The mobile shopping and delivery component is configured to provide an available inventory of the mobile delivery platform from the database to the user input device and to receive an order. The shopping and delivery server further comprises a communications module. The communications module is configured to communicate with and arrange and coordinate a delivery of the order by the mobile delivery platform. The shopping and delivery server further comprises a tracking component for tracking the mobile delivery platform along the preprogrammed route and providing an update on the order to the user input device. The shopping and delivery server further comprises a payment component for accepting a payment for and completing the order.

The subject matter disclosed and claimed herein, in an additional embodiment thereof, comprises, a method of providing an ordering and delivery service. The method comprises providing a mobile delivery platform stocked with an inventory of convenience items and beginning a preprogrammed delivery route. The method further comprises a shopping and delivery server receiving an order from a user interface over the internet. The method continues by notifying the mobile delivery platform of the order from the user interface while traversing the preprogrammed route. The method continues by alerting a customer of the mobile delivery platform proximity and the customer instructing the mobile delivery platform to stop at a delivery location. The delivery location may be a predetermined stop along the preprogrammed route, or a location that deviates from the preselected route. The method continues by accepting a payment and completing the delivery.

The subject matter disclosed and claimed herein, in an additional embodiment thereof, comprises, a method of providing an ordering and delivery service via a mobile delivery platform. A user input electronically connects to a shopping and delivery server over a network. The user input device comprises a non-transitory, computer-readable medium comprising software instructions that, when executed by at least one processor, causes the at least one processor to access the shopping and delivery server via a network. The mobile delivery platform comprises a delivery vehicle configured to carry an inventory of convenience items for sale and delivery along a preprogrammed route. The mobile delivery platform further comprises a server communications module for interacting with the shopping and delivery server.

The method begins when the mobile delivery platform begins a preprogrammed delivery route. Once the mobile delivery platform is close by, the shopping and delivery server alerts the customer of the proximity so that the customer may place an order through the user input device. The customer then selects a home delivery option or a customer pick-up option. If the home delivery option is selected, the mobile delivery platform deviates from the preprogrammed path proceeding directly to the customer's house and completes the delivery. The mobile delivery platform then returns to the preprogrammed route. If the customer pick-up option is selected, the mobile delivery platform stops at a location along the route selected by the user. The customer may then pick up the order or continue in person shopping. Once the order is picked up and any in person shopping is completed, the shopping and delivery server accepts a payment and completes the purchase. The mobile delivery platform then continues along the preprogrammed route.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of one embodiment of a mobile shopping and delivery system of the present invention in accordance with the disclosed architecture.

FIG. 2 illustrates a flowchart of a computer implemented method of providing a mobile shopping and delivery service of the present invention in accordance with the disclosed architecture.

FIG. 3 illustrates a flowchart of a computer implemented method of providing a mobile shopping and delivery service of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, provides users with a software application and method for delivering convenience store items via a bus that travels on a fixed route. The invention enables users to order convenience store items on the application and trach the bus, receiving an alert when the vehicle is nearby. Users may secure payments through the application via credit or debit card or online payment platforms to obtain food, beverages, alcohol, and other convenience items. The application may include a fixed membership fee to use the application and a non-member option to purchase items at higher prices from the vehicle. The invention further enables items to be delivered to the doorstep or lockbox only accessible to delivery drivers to provide a contactless delivery.

The mobile convenience store system combines a transit bus and software application to offer item purchase and delivery to customers. People can download the software application and sign up for a recurring membership to purchase items from the mobile store. Non-members using the system would be charged a premium. Users can purchase the items via the App for delivery by the bus. The bus can have an integrated cooler to keep beverages and food items cool during transport. The bus would travel on a fixed route stopping at places near a customer's home. Alternatively, the bus could deliver the items directly to the front door or lockbox. Payment is made securely through the App. An alert is sent to the user via the App when the bus is nearby.

Without limiting the forgoing, the App notifies the customer when the bus is in proximity to the customer, and the customer can signal the bus to stop directly at their house. The customer can then come out and receive the pre-ordered items. The customer may also impulse shop by boarding the bus and viewing the products on the shelves, racks, coolers, or freezers. This option gives the customer an “on demand” access to all of the products curbside. The App is designed to accept orders and communicate the orders to a bus driver who fulfills the orders. The App may include a version for the driver, a version for inventory and subscriber database management, and a customer interface version for customer orders.

The bus is able to stop at any home or business that is accessible to the bus. The bus may have a service window where customers can walk up to and pick up an order to provide a limited contact delivery option. A membership feature allows a large number of customers to pay a small monthly fee to cost share the expense that traditional delivery services would charge for each delivery. By paying the monthly fee, the customer is able to stop the bus on its route every time it is near. Additionally, the bus may be configured to employ exterior advertising as an additional revenue source.

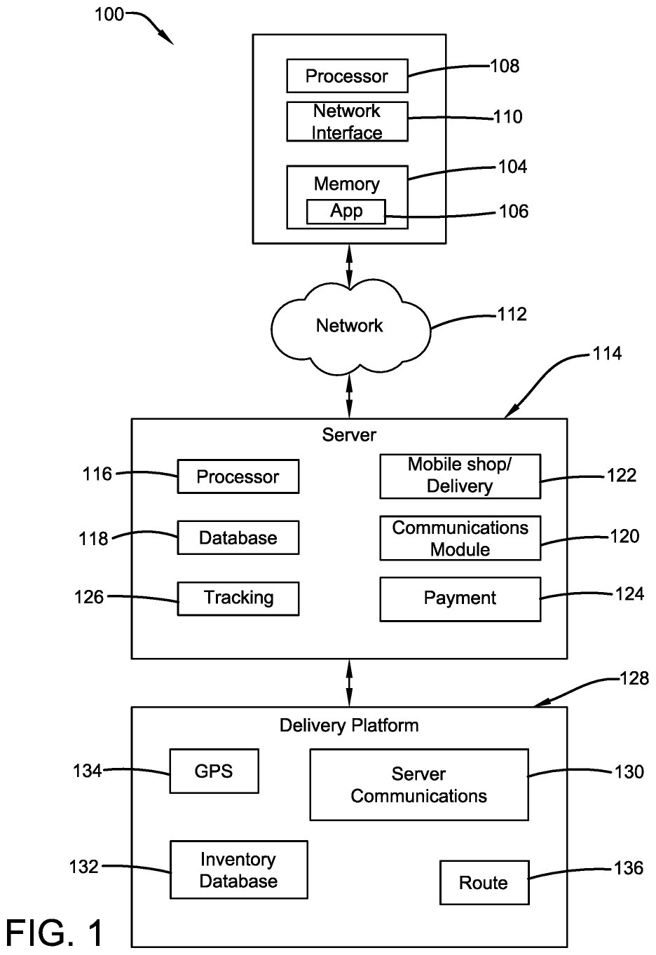

Referring initially to the drawings, FIG. 1 illustrates a diagrammatic view of one embodiment of a mobile shopping and delivery system 100. The mobile shopping and delivery system 100 comprises a user input device 102, a shopping and delivery server 114, and a mobile delivery platform 128. The user input device 102 may be a mobile electronic device or other internet connected user input, such as a smart phone, an electronic pad, a computer, a smart watch, a digital assistant, or any other internet connected communication device.

The user input device 102 is equipped with at least one processor 108, a network interface 110, and a memory. The at least one processor 108 may be a processing system of the mobile electronic device and is configured to execute instructions that are stored in the memory. The user input device 102 comprises a non-transitory, computer-readable medium 104 comprising software instructions 106 that, when executed by at least one processor 108, causes the at least one processor 108 to access the shopping and delivery 114 server via a communications network 112 using the network interface 110. The software instructions 106, typically in the form of an App, are stored in the memory and allow the user input device 102 to perform methods of the present technology when executed by the at least one processor 108.

The mobile delivery platform 128 comprises a delivery vehicle 140 configured to carry an inventory of convenience items for sale and delivery along a programmable route. The mobile delivery platform 128 is a delivery vehicle 140, such as a bus, van, truck, trailer, or similar vehicle retrofitted with shelving, coolers, freezers, bins, and the like, that is able to transport a variety of convenience items for sale and delivery. The mobile delivery platform 128 is equipped with a server communications module 138 for interacting with the shopping and delivery server 114, an inventory database 132 for tracking current inventory available for purchase, a global positioning system device (GPS) 134, and a preprogrammed route 136. The shopping and delivery server 114 interacts with the server communications module 138 to keep track of the current location of the delivery vehicle 140 through the GPS 134 as it tracks along the preprogrammed route 136 or any deviation from the preprogrammed route 136.

The shopping and delivery server 114 comprises a processor 116, a database 118, a communications module 120, and a mobile shopping and delivery component 122. The shopping and delivery server 114 is accessible by the user input device 102 via the communications network 112. The communications network 112 may be any of a number of private or public communications mechanisms such as the Internet, a local intranet, a Personal Area Network, a Local Area Network, a Wide Area Network, a Virtual Private Network, or the like. When the user input 102 is connected to the shopping and delivery server 114 via the network 112, the set of executable software instructions 106 allows the shopping and delivery server 114 to perform methods of the present technology when executed by the server processor 116.

The shopping and delivery server 114 is configured to provide an available inventory of the mobile delivery platform 128 from the database 118 to the user input device 102. The user can then view the available inventory and place an order. The shopping and delivery server 114 receives the order from the user input device 102 and communicates the order to the mobile delivery platform 128. The communications module 120 is configured to communicate with, arrange, and coordinate a delivery of the order by the mobile delivery platform 128.

The shopping and delivery server 114 further comprises a tracking component 126 configured to track the mobile delivery platform 128 along a route through the GPS 134. The shopping and delivery server 114 is further configured to alert the user input device 102 and provide an update of the proximity of the mobile delivery platform 128 based on a current location via the tracked GPS 134 along the preprogrammed route 136 and a status or update on the order. The shopping and delivery server 114 is further configured to either instruct the mobile delivery platform 128 to stop at a selected delivery location along the preprogrammed route 136 or deviate from the preprogrammed route 136 to a different location for delivery.

The shopping and delivery server 114 further comprises a payment component 126 for accepting a payment for and completing the order. Once the order is placed from the user input device 102, the payment component 126 either accepts an electronic payment, or places an electronic hold on the funds until delivery is complete. The payment component 126 is configured to accept payment information collected by the mobile delivery platform 128 should the customer complete additional shopping in person while picking up a delivery.

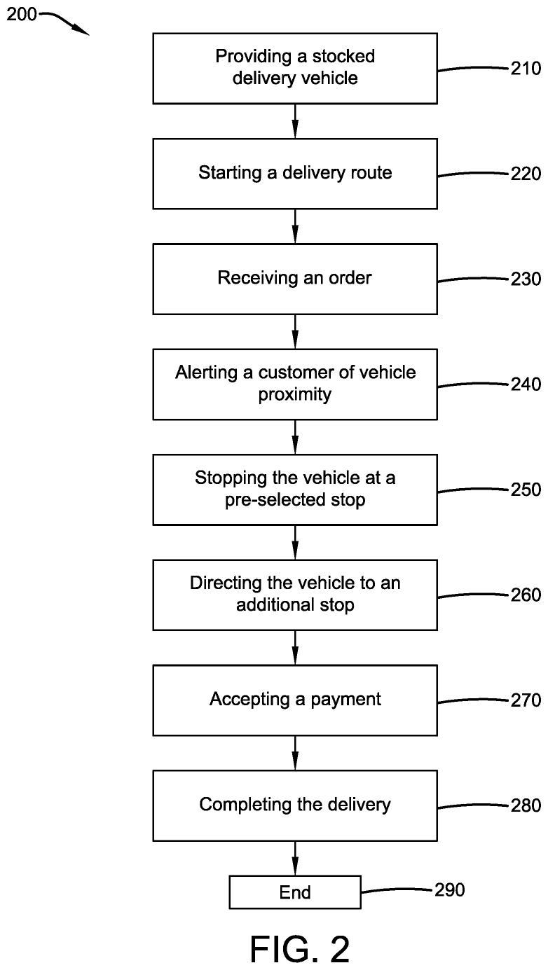

FIG. 2 illustrates a flow chart of an exemplary method 200 of providing an ordering and delivery service executable using the mobile shopping and delivery system 100 as described supra. The method 200 comprises providing a delivery vehicle 140 of a mobile delivery platform 128 stocked with an inventory of convenience items for sale and delivery at 210 and beginning a preprogrammed delivery route 136 at 220. The method 200 continues at 230 as a shopping and delivery server 114 receives an order from a user input device 102 over the internet.

The user input device 102 is equipped with at least one processor 108, a network interface 110, and a memory. The at least one processor 108 may be a processing system of the mobile electronic device and is configured to execute instructions that are stored in the memory. The user input device 102 comprises a non-transitory, computer-readable medium 104 comprising software instructions 106 that, when executed by at least one processor 108, causes the at least one processor 108 to access the shopping and delivery 114 server via a communications network 112 using the network interface 110.

The shopping and delivery server 114, using a communications module 128, then notifies the mobile delivery platform 128 of the order while traversing the preprogrammed delivery route 136. At 240 the shopping and delivery server 114 uses a GPS 136 of the mobile delivery platform 128 to locate the delivery vehicle 140 and alert the customer of the proximity of the delivery vehicle 140. The customer then may instruct the shopping and delivery server 114 via the user input device 102 to stop at a delivery location. The delivery location may be a predetermined stop along the preprogrammed route selected at 250, or a location that deviates from the preselected route at 260. The method continues at 270 by the shopping and delivery server 114 accepting a payment sent from the user input device 102. The method continues at 270 by completing the delivery and ends at 290 as the delivery vehicle 140 proceeds back along the preprogrammed delivery route 136.

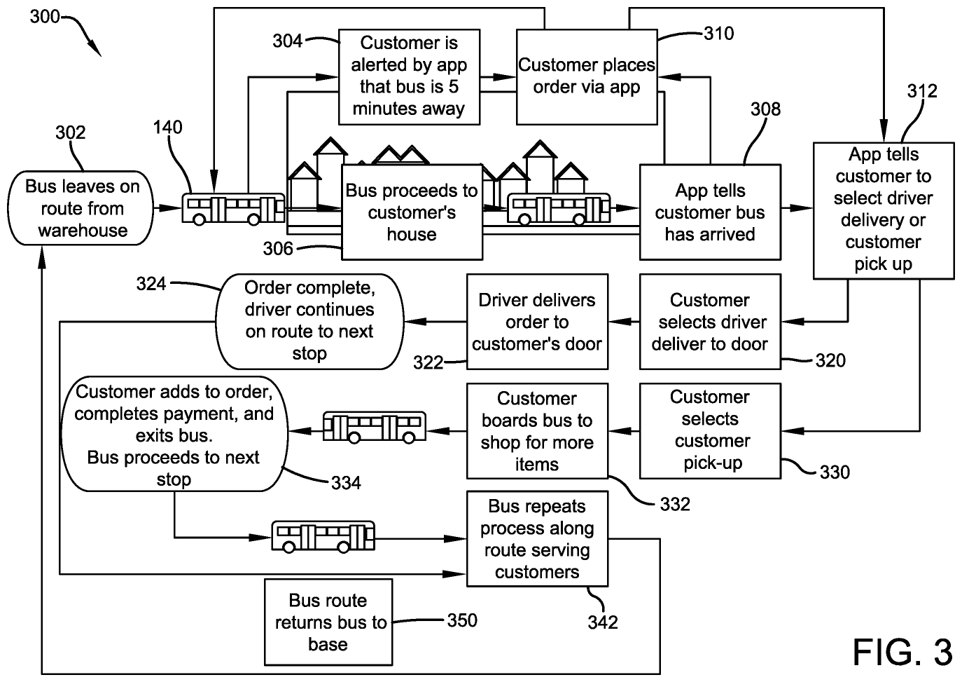

FIG. 3 illustrates a flow chart of an additional exemplary method 300 of providing an ordering and delivery service executable using the mobile shopping and delivery system 100 as described supra. A mobile delivery platform 128 comprises a delivery vehicle 140 configured to carry an inventory of convenience items for sale and delivery along a programmable route. The mobile delivery platform 128 is equipped with a server communications module 138 for interacting with a shopping and delivery server 114, an inventory database 132 for tracking current inventory available for purchase, a global positioning system device (GPS) 134, and a preprogrammed route 136. The shopping and delivery server 114 interacts with the server communications module 138 to keep track of the current location of the delivery vehicle 140 through the GPS 134 as it tracks along the preprogrammed route 136 or any deviation from the preprogrammed route 136.

A user input device 102 is equipped with at least one processor 108, a network interface 110, and a memory. The at least one processor 108 may be a processing system of the mobile electronic device and is configured to execute instructions that are stored in the memory. The user input device 102 comprises a non-transitory, computer-readable medium 104 comprising software instructions 106 that, when executed by at least one processor 108, causes the at least one processor 108 to access the shopping and delivery 114 server via a communications network 112 using the network interface 110.

The shopping and delivery server 114 comprises a processor 116, a database 118, a communications module 120, and a mobile shopping and delivery component 122. The shopping and delivery server 114 is accessible by the user input device 102 via the communications network 112. The shopping and delivery server 114 is configured to provide an available inventory of the mobile delivery platform 128 from the database 118 to the user input device 102. The shopping and delivery server 114 receives the order from the user input device 102 and communicates the order to the mobile delivery platform 128. The communications module 120 is configured to communicate with, arrange, and coordinate a delivery of the order by the mobile delivery platform 128.

The shopping and delivery server 114 further comprises a tracking component 126 configured to track the mobile delivery platform 128 along a route through the GPS 134. The shopping and delivery server 114 is further configured to alert the user input device 102 and provide an update of the proximity of the mobile delivery platform 128 based on a current location via the tracked GPS 134 along the preprogrammed route 136 and a status or update on the order. The shopping and delivery server 114 is further configured to either instruct the mobile delivery platform 128 to stop at a selected delivery location along the preprogrammed route 136 or deviate from the preprogrammed route 136 to a different location for delivery.

The method 300 begins by providing a delivery vehicle 140 of the mobile delivery platform 128 stocked with an inventory of convenience items for sale and delivery at and beginning a preprogrammed delivery route 136 at 302. The method 200 continues at 304 as the shopping and delivery server 114 alerts the customer of a proximity of the mobile delivery platform 128. Alternatively, the delivery vehicle 140 proceeds directly to the customer's residence at 306, if it is along the preprogrammed route 136, and the shopping and delivery server 114 alerts the customer that the delivery vehicle 140 has arrived.

In either event, the method continues at 310 where the customer places an order to the shopping and delivery server 114 using the user input device 102. The method 300 continues at 312 as the shopping and delivery server 114 offers a home delivery option or a customer pick-up option. If the customer selects the home delivery option at 320, the delivery vehicle 140 may deviate from the preprogrammed route 136 and proceed directly to the customer's residence at 322. The mobile delivery platform 128 then delivers and completes the order at 324 and returns to the preprogrammed route 136 at 340. The order may be completer as the shopping and delivery server 114 accepts a payment to complete the purchase.

If the customer selects the customer pick-up option at 330, the delivery vehicle 140 proceed to a preprogrammed stopping location. When the customer arrives at the preprogrammed stopping location, the customer may pick up the order and the shopping and delivery server 114 accepts a payment to complete the purchase. The delivery vehicle would then return to the preprogrammed route 136 at 340. Alternatively, at 332, the customer may board the delivery vehicle 140 and continue shopping in person. At 334, the customer finishes the additional shopping and the shopping and delivery server 114 accepts a payment to complete the purchase. Then, as before, the delivery vehicle would then return to the preprogrammed route 136 at 340. The method ends at 350 as the delivery vehicle completes the preprogrammed route 136 and proceeds to restock for the next delivery cycle.

It is contemplated that the mobile shopping and delivery system 100, and methods 200 and 300 of using the same constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile shopping and delivery system comprising:
a user input device;
a mobile delivery platform; and
a shopping and delivery server configured to:
provide an available inventory of the mobile delivery platform to the user input device;
receive an order from the user input device;
communicate the order to the mobile delivery platform;
arrange for a delivery of the order; and
coordinate the delivery of the order.

2. The mobile shopping and delivery system of claim 1, wherein the user input device comprises a non-transitory, computer-readable medium comprising software instructions that, when executed by at least one processor, causes the at least one processor to access the shopping and delivery server.

3. The mobile shopping and delivery system of claim 2, wherein the at least one processor is a processing system of a mobile electronic device.

4. The mobile shopping and delivery system of claim 1, wherein the mobile delivery platform comprises a bus.

5. The mobile shopping and delivery system of claim 1, wherein the mobile delivery platform is configured to traverse a preprogrammed route.

6. The mobile shopping and delivery system of claim 1, wherein the shopping and delivery server is further configured to instruct the mobile delivery platform to deviate from a preprogrammed route.

7. The mobile shopping and delivery system of claim 1, wherein the shopping and delivery server is further configured to track the mobile delivery platform along a route.

8. The mobile shopping and delivery system of claim 1, wherein the shopping and delivery server is further configured to accept a payment for and complete the order.

9. The mobile shopping and delivery system of claim 1, wherein the shopping and delivery server is further configured to provide an update on the order to the user input device.

10. The mobile shopping and delivery system of claim 1, wherein the shopping and delivery server is further configured to provide an update to the user input device on a current location of the mobile delivery platform.

11. A method of providing an ordering and delivery service comprising:
a mobile delivery platform traversing a preprogrammed route; and
a shopping and delivery server receiving an order from a user input device over the internet;
notifying the mobile delivery platform of the order while traversing the preprogrammed route;
alerting a customer of the mobile delivery platform proximity;
instructing the mobile delivery platform to stop at a delivery location; and
completing a delivery.

12. The method of claim 11, wherein the delivery location is a location along the preprogrammed route.

13. The method of claim 11, wherein the delivery location is a location that deviates from the preprogrammed route.

14. The method of claim 11 further comprising the shopping and delivery server accepting a payment to complete a purchase.

15. A method of providing an ordering and delivery service via a mobile delivery platform through a user input device electronically connected to a shopping and delivery server over a network, the method comprising:
beginning a preprogrammed delivery route;
alerting a customer of a proximity of the mobile delivery platform;
receiving an order to the shopping and delivery server via the user input device;
offering a home delivery option or a customer pick-up option;
completing the selected delivery option; and
continuing the preprogrammed delivery route.

16. The method of claim 15 further comprising diverting from the preprogrammed delivery route if the home delivery option is selected.

17. The method of claim 15 further comprising stopping at a preprogrammed stopping location selected by the user if the customer pick-up option is selected.

18. The method of claim 17 further comprising allowing the user to continue shopping on the mobile delivery platform in person.

19. The method of claim 15 further comprising accepting a payment to complete a purchase.

20. The method of claim 15 further comprising directly proceeding a user's residence if it is located along the preprogrammed delivery route.
